(19) United States
(12) Patent Application Publication
(10) Pub. No.: US 2009/0148771 A1
(43) Pub. Date: Jun. 11, 2009

(54) CATHODE AND NONAQUEOUS ELECTROLYTE BATTERY

(75) Inventors: Takehiko Ishii, Fukushima (JP); Mikio Watanabe, Kanagawa (JP); Hideki Nakai, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/368,833

(22) Filed: Feb. 10, 2009

(30) Foreign Application Priority Data
Feb. 13, 2005 (JP) 2008-031343

(51) Int. Cl. H01M 4/58; H01B 1/04

(52) U.S. Cl. 429/221; 429/231.8; 429/231.95; 429/223; 429/224; 429/229; 429/231.5; 429/231.6; 252/502

(57) ABSTRACT

A nonaqueous electrolyte battery includes a cathode having a cathode active material layer including a lithium phosphate compound having an olivine structure; an anode having an anode active material; and a nonaqueous electrolyte, wherein the cathode active material layer includes a carbon material, of which a ratio of a peak intensity at 1,360 cm⁻¹ to a peak intensity at 1,580 cm⁻¹, obtained by Raman spectrum analysis through measurement using argon laser radiation at a wavelength of 514.52 nm, is 0.25 or more and 0.8 or less; and fibrous carbon.

### CROSS REFERENCES TO RELATED APPLICATIONS

The present application claims priority to Japanese Patent Application JP 2008-031343 filed in the Japanese Patent Office on Feb. 13, 2008, the entire contents of which is being incorporated herein by reference.

### BACKGROUND

The present application relates to cathodes and nonaqueous electrolyte batteries, and, in particular, to a cathode and a nonaqueous electrolyte battery, which have high capacity and high output characteristics.

In recent years, portable electronic equipments, such as camcorders (video tape recorders), mobile phones and laptop computers, have made their appearance, and the sizes and weights of them have been reduced. In addition, for portable power sources for these electronic equipments, research and development for increasing the energy densities of batteries, in particular, secondary batteries have been vigorously pursued.

Expectations in regard to batteries using nonaqueous electrolytic solutions, especially, lithium ion secondary batteries have been increased and markets for them have significantly grown, because they may provide higher energy densities as compared to lead batteries and nickel-cadmium batteries, which are aqueous electrolytic solution secondary batteries in the prior art.

In particular, in recent years, examinations aiming at the upsizing and higher outputs of lithium ion secondary batteries have been actively performed, because the characteristics, including lightness in weight and high energy density, of the batteries are suitable for use in electric vehicles and hybrid electric vehicles.

Cathodes of oxides such as LiCoO₂, LiNiO₂ and LiMn₂O₄ as cathode active materials are generally used in nonaqueous secondary batteries typified by a lithium ion secondary battery. This is because a high capacity and a high voltage are provided and high chargeability is excellent, resulting in an advantage in reducing the sizes and weights of portable equipments.

However, heating of these cathodes in the state of charge results in initiation of discharge of oxygen at 200° C. to 300° C. The discharge of oxygen involves the risk of thermal runaway of a battery due to use of a flammable organic electrolytic solution as an electrolytic solution. Therefore, the uses of the oxide cathodes preclude provision of safety, particularly in large-sized batteries.

In contrast to this, it is indicated by J. Electrochem. Soc., Vol. 144, p. 1188 that a cathode material having an olivine structure reported by A. K. Padhi et al. does not result in discharge of oxygen even exceeding 350° C. and is significantly excellent in safety. Such cathode materials include, e.g., lithium iron phosphate mainly consisted of iron (LiFe₁₋ₓMxPC₄, wherein M is at least one metallic material selected from manganese (Mn), nickel (Ni), cobalt (Co) and the like).

The cathode material having the olivine structure has a significantly high degree of potential flatness because discharge and charge proceed in a state of coexistence of two layers of LiFePO₄ and FePO₄. Therefore, there is a characteristic of performing constant-current/constant-voltage charge, which is a charging method in a typical lithium-ion battery, in a constant-current charge state in the majority of cases. Accordingly, the battery using the cathode material having the olivine structure allows short charge time, as compared to cathode materials in the prior art, such as LiCoO₂, LiNiO₂ and LiMn₂O₄, in case of charge in the same charge rate.

However, such a cathode material having an olivine structure has such a problem that an adequate discharge and charge capacity is not provided according to the increase in overvoltage in large-current discharge and charge due to a slow insertion-elimination reaction of lithium during discharging and charging a battery and a high electrical resistance as compared to lithium cobaltate (LiCoO₂) as used in the prior art.

Various approaches of such a problem have been performed, including, e.g., a technology, exhibited in Japanese Patent Application Laid-Open (JP-A) Nos. 2001-110414 and 2003-36889, of increasing a discharge and charge capacity in large-current discharge and charge by carrying electrically-conductive fine particles on the surfaces of particles of lithium iron phosphate to improve the electroconductivity of an active material surface.

Commonly, powdered carbon such as carbon black, flaky carbon such as graphite, and fibrous carbon have been also generally mixed with the above-mentioned cathode material having the olivine structure to decrease the electrical resistance of a cathode.

In addition, JP-A No. 2002-110162 exhibits that electron conductivity in a cathode is enhanced using a cathode active material with a sufficiently large specific surface area, obtained with primary particles of lithium iron phosphate, having particle diameters of 3.1 μm or smaller.

JP-A No. 2005-251554 also exhibits a technology of using a binder with a high binding capacity to improve adhesiveness between a cathode active material and a conductive agent, between the cathode active material and a cathode collector, and between the cathode collector and the conductive agent, and to improve load characteristics during large-current discharge and charge.

However, use of a cathode active material as descried in JP-A No. 2001-110414, 2003-36889, 2002-110162 or 2005-251554 is effective in improving large-current discharge characteristics in an early stage of electric discharge, but results in cycle deterioration increasing with passing the cycle of large-current discharge and charge. Particularly, battery resistance is greatly increased with increasing the number of cycles during the large-current discharge cycle, causing the risks of reduction in battery capacity and inadequate output in an electronic equipment that may require heavy load output, such as an electric power tool, to preclude the use of the electronic equipment.

Although JP-A No. 2005-251554 also discloses that use of a material with the high binding capacity of a binder results in improvement in cycle life property in low discharge and charge current, no finding relating to a large-current discharge cycle such as 5C or 10C discharge has been observed.

### SUMMARY

Such problems in the above described approaches are considered to be caused by reasons described below. Because a battery generates heat depending on the amount of current passing through the battery, the interior of the battery discharging large current is in a significantly high temperature state. Repeated discharge and charge in the high temperature state of the interior of the battery accelerate decomposition of an electrolytic solution to form such a coating as deteriorating the electroconductivity of an anode surface.

In a battery using a cathode active material having an olivine structure, because the cathode active material has a relatively small particle diameter and a large specific surface area, the adsorption amount of water on a particle surface is increased as compared to a cathode active material having another structure, but the reaction of decomposition of an electrolytic solution as described above is considered to significantly proceed with increasing a water content in the cathode. More specifically, the water in the cathode is considered to elute into the electrolytic solution to further accelerate the decomposition of the electrolytic solution. This is considered to result in increase in the amount of a coating on an anode surface with passing a discharge and charge cycle to increase battery resistance, particularly in the battery using the cathode active material having the olivine structure.

Accordingly, it is desirable to solve the above-mentioned problems and to provide a cathode and a nonaqueous electrolyte battery, which have high capacities and high output characteristics.

According to an embodiment, there is provided a nonaqueous electrolyte battery including: a cathode having a cathode active material layer including a lithium phosphate compound having an olivine structure; an anode having an anode active material; and a nonaqueous electrolyte, wherein the cathode active material layer includes: a carbon material, of which a ratio (I₁₃₆₀/I₁₅₈₀) of a peak intensity (I₁₃₆₀) at 1,360 cm⁻¹ to a peak intensity (I₁₅₈₀) at 1,580 cm⁻¹, obtained by Raman spectrum analysis through measurement using argon laser radiation at a wavelength of 514.52 nm, is 0.25 or more and 0.8 or less; and fibrous carbon.

The above-mentioned lithium phosphate compound is characterized by being represented by Chemical Formula I:

LiMₓPO₄ (Chemical Formula I)

wherein M is at least one selected from the group consisting of cobalt Co, manganese Mn, iron Fe, nickel Ni, magnesium Mg, aluminum Al, boron B, titanium Ti, vanadium V, niobium Nb, copper Cu, zinc Zn, molybdenum Mo, calcium Ca, strontium Sr, tungsten W and zirconium Zr; and X is 0≦x≦1.

A mean particle diameter of the above-mentioned lithium phosphate compound is preferably 50 nm or larger and 500 nm or smaller. Because the lithium phosphate compound with such a mean particle diameter has a significantly large specific surface area, an effect obtained by inclusion of such a carbon material as described above is enhanced. In the lithium phosphate compound, the effect obtained by inclusion of such a carbon material as described above is enhanced with decreasing the mean particle diameter.

According to an embodiment, there is also provided a cathode including: a carbon material, of which a ratio (I₁₃₆₀/I₁₅₈₀) of a peak intensity (I₁₃₆₀) at 1,360 cm⁻¹ to a peak intensity (I₁₅₈₀) at 1,580 cm⁻¹, obtained by Raman spectrum analysis through measurement using argon laser radiation at a wavelength of 514.52 nm, is 0.25 or more and 0.8 or less; and fibrous carbon.

According to an embodiment, combined use of such a carbon material as described above and high electroconductive carbon such as fibrous carbon for use as a conductive agent may result in inhibition of water, adsorbed by a cathode active material, from eluting into an electrolytic solution, and in maintenance of electroconductivity.

According to an embodiment, there can be provided a cathode and a nonaqueous electrolyte battery, having high capacities and high output characteristics, wherein increase in battery resistance in the early stage of the cycle of a nonaqueous electrolyte battery and increase in battery resistance with passing the discharge and charge cycle are prevented.

Other features and advantages will be apparent from the following description taken in conjunction with the accompanying drawings, in which like reference characters designate the same or similar parts throughout the figures thereof.

Additional features and advantages are described herein, and will be apparent from the following Detailed Description and the figures.

### BRIEF DESCRIPTION OF THE FIGURES

FIG. 1 is a sectional view exemplifying one configuration example of a nonaqueous electrolytic solution battery according to one embodiment.

FIG. 2 is a sectional view showing a magnified part of a wound electrode body shown in FIG. 1.

FIG. 3 is a graph showing the assessment results of Example 1.

FIG. 4 is a graph showing the assessment results of Example 2.

### DETAILED DESCRIPTION

An embodiment is described below referring to the drawings.

### [Structure of Nonaqueous Electrolyte Secondary Battery]

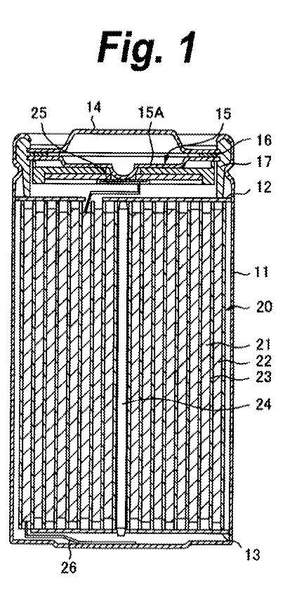

FIG. 1 shows the cross section structure of a nonaqueous electrolyte battery according to one embodiment (hereinafter appropriately referred to as secondary battery). This battery, for example, is a lithium ion secondary battery.

As shown in FIG. 1, this secondary battery, which is a so-called cylindrical-type battery, includes a wound electrode body 20 in which a belt-shaped cathode 21 and a belt-shaped anode 22 are wound via a separator 23, in a substantially hollow cylindrical battery can 11. The battery can 11, which is composed of iron (Fe) plated with, e.g., nickel (Ni), has one end that is closed and the other end that is opened. In the battery can 11, a pair of insulating plates 12 and 13 perpendicular to a winding surface is placed so as to sandwich the wound electrode body 20.

A battery cap 14, a safety valve mechanism 15 placed in the battery cap 14, and a heat-sensitive resistance element (positive temperature coefficient (PTC) element) 16 are swaged into the open end of the battery can 11 via a gasket 17, and the interior of the battery can 11 is sealed. The battery cap 14 is composed of, e.g., a material similar to that of the battery can 11.

The safety valve mechanism 15, which is electrically connected to the battery cap 14 via the heat-sensitive resistance element 16, cuts electrical connection between the battery cap 14 and the wound electrode body 20 by reversing a disc board 15A reverse when the internal pressure of the battery is not less than a certain level due to internal short-circuit or heating from the outside. The heat-sensitive resistance element 16 limits current by increasing a resistance value to prevent abnormal heat generation due to large current when temperature rises. The gasket 17 is composed of, e.g., an insulating material and has a surface to which asphalt is applied.

The wound electrode body 20 is wound around, e.g., a center pin 24. A cathode lead 25 composed of aluminum (Al), etc., is connected to the cathode 21 of the wound electrode body 20, while an anode lead 26 composed of nickel (Ni), etc., is connected to the anode 22. The cathode lead 25 is electrically connected to the battery cap 14 by being welded to the safety valve mechanism 15, while the anode lead 26 is welded and electrically connected to the battery can 11.

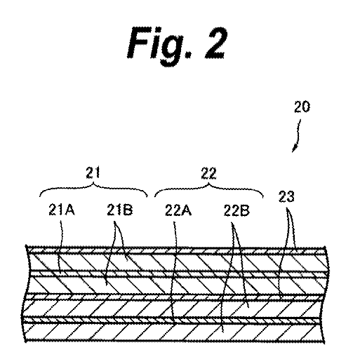

FIG. 2 shows an enlarged part of the wound electrode body 20 shown in FIG. 1.

### [Cathode]

A cathode 21 has, e.g., a cathode collector 21A and cathode active material layers 21B disposed on both surfaces of the cathode collector 21A. Further, the cathode 21 may also has a region in which the cathode active material layer 21B is present only on one surface of the cathode collector 21A. The cathode collector 21A is composed of, e.g., metallic foil such as aluminum (Al) foil.

The cathode active material layer 21B includes, e.g., a cathode active material, a conductive agent such as fibrous carbon and carbon black, and a binders such as polyvinylidene fluoride (PVdF). The cathode active material layer 21B further includes a carbon material, of which a ratio (I₁₃₆₀/I₁₅₈₀) of a peak intensity (I₁₃₆₀) at 1,360 cm⁻¹ to a peak intensity (I₁₅₈₀) at 1,580 cm⁻¹, obtained by Raman spectrum analysis through measurement using argon laser radiation at a wavelength of 514.52 nm, is 0.25 or more and 0.8 or less (hereinafter, appropriately referred to as low-crystalline carbon).

Further, as a result of Raman analysis on a graphite material, a Raman band (G-band) at 1,580 cm⁻¹ due to a graphite structure and Raman bands (D-, D′-bands) at 1,360 and 1,620 cm⁻¹ due to disorder of the graphite structure are observed. The intensity ratio of the D-band to the G-band is generally referred to as an R-value (ratio (I₁₃₆₀/I₅₈₀) of peak intensity (I₁₃₆₀) at 1,360 cm⁻¹ to peak intensity (I₁₅₈₀) at 1,580 cm⁻¹) as an index to indicate the degree of crystallinity of the graphite material. In contrast, because lower crystallization of the graphite material results in an increased peak half-width due to the G-band grows larger, observation of the D′-band at 1,620 cm⁻¹ is often precluded by interference of the peak.

This low-crystalline carbon is obtained, for example, by high-temperature heat treatment of an organic material such as a coal tar pitch and grinding/classifying the heat-treated organic material. The high-temperature heat treatment is performed, e.g., for an appropriate time to hold the organic material in the range of 1,800° C. to 2,400° C. in an atmosphere of an inert gas such as an argon gas.

Lithium phosphate compounds having olivine structures include, e.g., compounds represented by Chemical Formula I:

LiMxPO₄ (Chemical Formula I)

(wherein M is at least one selected from the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W) and zirconium (Zr); and X is 0≦x≦1.)

Further, a carbon material, etc., may be carried on the surfaces of the lithium phosphate compound, e.g., to improve electroconductivity.

A mean particle diameter of the lithium phosphate compound is preferably 50 nm or larger and 500 μm or smaller. A reaction area of an active material can be increased by using a lithium phosphate compound with a relatively small particle diameter. The lithium phosphate compound with such a mean particle diameter also has a large specific surface area and a large amount of adsorbed water. Therefore, an effect obtained by using such low-crystalline carbon as described above is enhanced.

The mean particle diameter of the lithium phosphate compound is calculated from the mean value of measured longer diameters on observed images obtained, e.g., from a scanning electron microscope (SEM).

A conductive agent included in the cathode active material layer is particularly preferably fibrous carbon. The fibrous carbon may lead to reduction in the number of contacts among conductive agents in case of use as the conductive agent as compared to case of use of a substantially spherical carbon material, because of having longer particle diameters that are larger than those of the substantially spherical carbon material. Because the conductive agents are connected by a binder, the reduction in the number of contacts may result in reduction in the amount of the binder in a conductive path to inhibit increase in resistance. Therefore, the use of the fibrous carbon allows improvement in electroconductivity in the direction of the thickness of the cathode active material layer.

As the fibrous carbon, for example, a so-called gas vapor-grown carbon fiber formed by a gas phase method may be used. The vapor-grown carbon fiber can be produced, e.g., by a method of blowing an organic compound vaporized with iron to be a catalyst under a high-temperature atmosphere. Although all of the vapor-grown carbon fibers, which are in a state without being processed following production; heat-treated at around 800-1,500° C.; and graphitization-treated at around 2,000-3,000° C., can be used, the vapor-grown carbon fiber, which is heat-treated or graphitization-treated, is preferred because of having higher crystallinity of carbon and possessing high conductivity and a high-breakdown voltage characteristic.

For example, a mean fiber diameter of the fibrous carbon is preferably 1 nm or larger and 200 nm or smaller, more preferably 10 nm or larger and 200 nm or smaller. An aspect ratio calculated from (mean fiber length/mean fiber diameter) using a mean fiber diameter and a mean fiber length is preferably a mean of 20 or more and 20,000 or less, more preferably a mean of 20 or more and 4,000 or less, further preferably 20 or more and 2,000 or less.

As described above, inclusion of low-crystalline carbon in a cathode can suppress increase in battery voltage in the early stage of a cycle and also suppress the rate of an increase in battery resistance, associated with increase in the number of cycles during a large-current discharge cycle. This is considered because the above-mentioned carbon material adsorbs water adsorbed by a lithium phosphate compound which is a cathode active material and the carbon material retains the water to prevent the water from eluting into an electrolytic solution.

### [Anode]

An anode 22 has, e.g., an anode collector 22A and anode active material layers 22B disposed on both surfaces of the anode collector 22A. Further, the anode 22 may also has a region in which the anode active material layer 22B is present only on one surface of the anode collector 22A. The anode collector 22A is composed of, e.g., metallic foil such as copper (Cu) foil.

The anode active material layer 22B contains, e.g., an anode active material, and may further contain, as necessary, another material not contributing to charge, such as a conductive agent, a binder or a viscosity modifier. Conductive agents include a graphite fiber, a metal fiber, or a metal powder. Binders include a fluorine-containing macromolecular compound such as polyvinylidene fluoride (PVdF); or a synthetic rubber such as styrene-butadiene rubber (SBR) or ethylene-propylene-diene rubber (EPDR).

The anode active material is composed of any one or more of anode materials capable of electrochemically occluding and releasing lithium (Li) at a potential with respect to lithium metal of 2.0 V or lower.

Anode materials capable of occluding and releasing lithium (Li) include, e.g., carbon materials, metal compounds, oxides, sulfides, lithium nitrides such as LiN₃, a lithium metal, metals alloyed with lithium, or macromolecular materials.

Carbon materials include, e.g., non-graphitizable carbon, graphitizable carbon, graphite, pyrolytic carbon, cokes, glassy carbon, organic polymer compound sintered bodies, carbon fibers, or activated carbon. Among them, cokes include a pitch coke, a needle coke, or a petroleum coke. An organic polymer compound sintered body refers to a macromolecular material, such as a phenol resin or a furan resin, carbonized by being burnt at appropriate temperature. There are also some organic polymer compound sintered bodies, which are classified into non-graphitizable carbon or graphitizable carbon. Further, macromolecular materials, include polyacetylene or polypyrrole.

Among such anode materials capable of occluding and releasing lithium (Li), ones with discharge and charge potentials relatively similar to that of lithium metal are preferred. This is because easiness of achieving higher energy density of a battery is increased with decreasing the discharge and charge potential of the anode 22. Especially, the carbon materials are preferred because of having crystal structures, which hardly change during discharge and charge to allow obtainment of high discharge and charge capacities, and of obtaining good cycle characteristics. Particularly, the graphite is preferred because of having a high electrochemical equivalent to allow obtainment of a high energy density. The non-graphitizable carbon is also preferred because excellent cycle characteristics can be obtained.

Anode materials capable of occluding and releasing lithium (Li) also include elemental lithium metal and the elementary substance, alloy or compound of a metallic or metalloid element which can be alloyed with lithium (Li). These are preferred because high energy densities can be obtained. Particularly, when they are used together with the carbon materials, they are more preferred because excellent cycle characteristics can be obtained while high energy densities can be obtained. Further, as used herein, alloys include ones consisting of one or more metallic elements and one or more metalloid elements in addition to two or more metallic elements. Structures of the alloys include a solid solution, eutectic crystal (eutectic mixture), an intermetallic compound, or a coexisting combination of two or more thereof.

Such metallic or metalloid elements include, e.g., tin (Sn), lead (Pb), aluminum (Al), indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y) or hafnium (Hf). These alloys or compounds include, e.g., ones represented by Chemical Formula: Ma_{f}Mb_{g}Liₕ or MaₛMcₜMdᵤ, wherein Ma represents at least one of metallic and metalloid elements which can be alloyed with lithium; Mb represents at least one of metallic and metalloid elements other than lithium and Ma; Mc represents at least one of non-metallic elements; Md represents at least one of metallic and metalloid elements other than Ma; and the values of f, g, h, s. t and u are f>0, g≧0, h≧0, s>0, t>0 and u≧0, respectively.

Especially, the elementary substances, alloys or compounds of metallic of metalloid elements of Group 4B in the short-form periodic table are preferred. Silicon (Si) or tin (Sn), or the alloys or compounds thereof, which may be amorphous or crystalline, are particularly preferred.

Anode material capable of occluding/releasing lithium further include oxides, sulfides, or other metal compounds such as lithium nitrides such as LiN₃. Oxides include MnO₂, V₂O₅, V₆O₁₃, NiS, and MoS. In addition, oxides having a relatively base potential and capable of occluding and releasing lithium include, e.g., iron oxide, ruthenium oxide, molybdenum oxide, tungsten oxide, titanium oxide, and tin oxide. Sulfides include NiS and MoS.

### [Separator]

For a separator 23, for example, a polyethylene porous film, a polypropylene porous film, a synthetic resin non-woven fabric, or the like can be used. These may be used in a single layer or may be in a layered structure, in which the above-mentioned materials are layered in a plurality of layers. The separator 23 is impregnated with a nonaqueous electrolytic solution which is a liquid electrolyte.

### [Nonaqueous Electrolytic Solution]

The nonaqueous electrolytic solution contains a liquid solvent, e.g., a nonaqueous solvent such as an organic solvent, and electrolyte salt dissolved in the nonaqueous solvent.

The nonaqueous solvent preferably contains at least one of, e.g., cyclic carbonic acid esters such as ethylene carbonate (EC) and propylene carbonate (PC), because a cycle characteristic can be improved. The nonaqueous solvent particularly preferably contains a mixture of ethylene carbonate (EC) and propylene carbonate (PC), because the cycle characteristic can be further improved.

The nonaqueous solvent also preferably contains at least one of chain carbonic acid esters such as diethyl carbonate (DEC), dimethyl carbonate (DMC), ethylmethyl carbonate (EMC) and methylpropyl carbonate (MFC), because a cycle characteristic can be further improved.

The nonaqueous solvent further preferably contains at least one of 2,4-difluoroanisole and vinylene carbonate (VC), because 2,4-difluoroanisole can improve a discharge capacity and vinylene carbonate (VC) can further improve a cycle characteristic. Particularly, the nonaqueous solvent containing a mixture of them is more preferred because both of the discharge capacity and the cycle characteristic can be improved.

The nonaqueous solvent mat further contain any one or two or more of butylene carbonate, γ-butyrolactone, γ-valerolactone, these compounds having some or all of hydrogen replaced by fluorine, 1,2-dimethoxyethane, tetrahydrofuran, 2-methyltetrahydrofuran, 1,3-dioxolan, 4-methyl-1,3-dioxolan, methyl acetate, methyl propionate, acetonitrile, glutaronitrile, adiponitrile, methoxy acetonitrile, 3-methoxypropionitrile, N,N-dimethylformamide, N-methylpyrrolidinone, N-methyloxazolidinone, N,N-dimethylimidazolidinone, nitromethane, nitroethane, sulfolane, dimethylsulfoxide, and trimethylphosphate.

Depending on an electrode to be combined, use of substances included in the aforementioned nonaqueous solvent group, having some or all of hydrogen atoms replaced by fluorine atoms sometimes results in increase in the reversibility of an electrode reaction. Accordingly, these substances may be also appropriately used.

For the electrolyte salt, a lithium salt may be used. Lithium salts include, e.g., inorganic lithium salts such as lithium hexafluorophosphate (LiPF₆), lithium tetrafluoroborate (LiBF₄), lithium hexafluoroarsenate (LiAsF₆), lithium hexafluoroantimonate (LiSbF₆), lithium perchlorate (LiClO₄) and lithium aluminum tetrachloride (LiAlCl₄); and perfluoroalkane sulfonic acid derivatives such as lithium trifluoromethanesulfonate (LiCF₃SO₃), lithium bis(trifluoromethanesulfonyl)imide (LiN(CF₃SO₂)₂), lithium bis(pentafluoroethanesulfonyl)imide (LiN(C₂F₅SO₂)₂) and lithium tris(trifluoromethanesulfonyl)methide (LiC(CF₃SO₂)₃), which may be used alone or in combination of two or more of them. Especially, the lithium hexafluorophosphate (LiPF₆) is preferred because of being capable of providing high ionic conductivity and improving a cycle characteristic.

### [Method of Producing Nonaqueous Electrolyte Secondary Battery]

This secondary battery can be produced, e.g., by a method as described below. First, for example, a cathode active material, low-crystalline carbon, a conductive agent, and a binder are mixed to prepare a cathode mixture, and this cathode mixture is dispersed in a solvent such as N-methylpyrrolidone to form cathode mixture slurry. Subsequently, this cathode mixture slurry is applied to a cathode collector 21A to perform drying of the solvent, followed by compression molding of the dried solvent by a roll press machine to form a cathode active material layer 21B to produce a cathode 21.

For example, an anode active material and a binder are also mixed to prepare an anode mixture, and this anode mixture is dispersed in a solvent such as N-methylpyrrolidone to form anode mixture slurry. Subsequently, this anode mixture slurry is applied to an anode collector 22A to perform drying of the solvent, followed by compression molding of the dried solvent by a roll press machine to form an anode active material layer 22B to produce an anode 22.

Then, a cathode lead 25 is attached to the cathode collector 21A by welding, etc., and an anode lead 26 is attached to the anode collector 22A by welding, etc. Subsequently, the cathode 21 and the anode 22 are wound via a separator 23 to weld the leading end of the cathode lead 25 to a safety valve mechanism 15 and to weld the leading end of the anode lead 26 to a battery can 11, the wound positive and anodes 21 and 22 are sandwiched by a pair of insulating plates 12 and 13, and the sandwiched electrodes are housed in the battery can 11.

Following housing of the positive and anodes 21 and 22 in the battery can 11, the above-mentioned electrolytic solution is injected into the battery can 11 to impregnate the separator 23 therewith. Subsequently, a battery cap 14, a safety valve mechanism 15, and a heat-sensitive resistance element 16 are fixed to the open end of the battery can 11 via a gasket 17 by swaging. A secondary battery shown in FIG. 1 can be produced as described above.

In this secondary battery, when being charged, for example, lithium ions are released from the cathode 21 and are occluded in the anode 22 via the electrolytic solution. When the battery is discharged, for example, the lithium ions are released from the anode 22 and are occluded in the cathode 21 via the electrolytic solution.

Use of the cathode produced as described above can suppress formation of a coating on the surface of the anode due to water adsorbed by a lithium phosphate compound which is a cathode active material, can suppress increase in battery resistance in the early stage of a cycle, and can also suppress increase in the rate of an increase in battery resistance, associated with increase in the number of cycles.

### EXAMPLES

Specific examples will be described in detail below, but the embodiments are not limited only to these examples.

### Example 1

In the examples described below, the mixture ratio of low-crystalline carbon and fibrous carbon is varied to form cathode active material layers, and measurement of the direct current resistances of batteries and cycle tests are performed.

### Example 1-1

### Cathode

Mixing of 86 parts by mass of lithium iron phosphate (LiFePO₄) coated with carbon as a cathode active material, 2 parts by mass of low-crystalline carbon, 2 parts by mass of fibrous carbon as a conductive agent, and 10 parts by mass of polyvinylidene fluoride (PVdF) as a binder was performed, and this mixture was dispersed in an additional amount of N-methyl-2-pyrrolidone to prepare a slurry-like cathode mixture. Further, the low-crystalline carbon was obtained by heat treatment of coal-tar pitch under an inert gas atmosphere at 2,000° C., and a ratio (I₁₃₆₀/I₁₅₈₀; R value) of a peak intensity (I₁₃₆₀) at 1,360 cm⁻¹ to a peak intensity (I₁₅₈₀) at 1,580 cm⁻¹, obtained by Raman spectrum analysis through measurement using argon laser radiation at a wavelength of 514.52 μm, was 0.3.

This slurry-like cathode mixture was uniformly applied to both surfaces of a cathode collector composed of aluminum (Al) foil having a thickness of 15 μm, and this collector was dried under reduced pressure for 12 hours under an atmosphere of 120° C., followed by pressurization molding of the dried collector by a roll press machine to form a cathode active material layer. Then, a cathode sheet, on which the cathode active material layer was formed, was cut out in a belt shape to form a cathode.

### [Anode]

Mixing of 90 parts by mass of artificial graphite and 10 parts by mass of polyvinylidene fluoride (PVdF) as a binder was performed, and this mixture was dispersed in an additional amount of N-methyl-2-pyrrolidone to prepare a slurry-like anode mixture. This slurry-like anode mixture was uniformly applied to both surfaces of an anode collector composed of copper (Cu) foil having a thickness of 15 μm, and this collector was dried under reduced pressure for 12 hours under an atmosphere of 120° C., followed by pressurization molding of the dried collector by a roll press machine to form an anode active material layer. Then, an anode sheet, on which the anode active material layer was formed, was cut out in a belt shape to form an anode.

### [Nonaqueous Electrolytic Solution]

A mixed solvent, in which ethylene carbonate (EC) and dimethyl carbonate (DMC) in equal parts were mixed, was used as a nonaqueous solvent, and this mixed solvent, in which 1 mol/l of lithium hexafluorophosphate (LiPF₆) as electrolyte salt was dissolved, was used.

### [Production of Nonaqueous Electrolyte Secondary Battery]

The above-mentioned positive and anodes were layered and wound via a microporous film consisting of polypropylene (PP) having a thickness of 25 μm to obtain a wound electrode body. This wound electrode body was housed in a metal case having a diameter of 18 mm and a height of 65 mm, and injection of a nonaqueous electrolytic solution was performed, followed by swaging a battery cap, to which a safety valve was connected, to produce a 18650-size cylindrical nonaqueous electrolyte secondary battery having a capacity of 1000 mAh.

### Comparative Example 1-1

A cylindrical nonaqueous electrolyte secondary battery was produced by the same method as in Example 1-1, except that a cathode contained no low-crystalline carbon, and 88 parts by mass of lithium iron phosphate (LiFePO₄), coated with carbon, as a cathode active material, 2 parts by mass of fibrous carbon as a conductive agent, and 10 parts by mass of polyvinylidene fluoride (PVdF) as a binder were mixed to obtain a cathode mixture.

### Comparative Example 1-2

A cylindrical nonaqueous electrolyte secondary battery was produced by the same method as in Example 1-1, except that a cathode contained no low-crystalline carbon, and 86 parts by mass of lithium iron phosphate (LiFePO₄), coated with carbon, as a cathode active material, 4 parts by mass of fibrous carbon as a conductive agent, and 10 parts by mass of polyvinylidene fluoride (PVdF) as a binder were mixed to obtain a cathode mixture.

### Comparative Example 1-3

A cylindrical nonaqueous electrolyte secondary battery was produced by the same method as in Example 1-1, except that a cathode contained no fibrous carbon as a conductive agent, and 88 parts by mass of lithium iron phosphate (LiFePO₄), coated with carbon, as a cathode active material, 2 parts by mass of low-crystalline carbon, and 10 parts by mass of polyvinylidene fluoride (PVdF) as a binder were mixed to obtain a cathode mixture.

### (a) Measurement of Direct Current Resistance

Constant-current charge of each cylindrical nonaqueous electrolyte secondary battery of Example and Comparative Examples was performed until a battery voltage reached 3.6 V at a constant current of 1 A, followed by measuring a voltage value when each current of 5, 10, 15 and 20 A was applied for 10 seconds in the state in which the secondary battery was charged at 50%. Subsequently, the gradients of lines formed by plotting the measured voltage and current values were calculated as initial direct current resistances (DCR). Following this, each direct current resistance ratio of Example and Comparative Examples was determined with respect to 100% of the initial direct current resistance of Comparative Example 1-1.

### (b) Cycle Test

Constant-current charge of each cylindrical nonaqueous electrolyte secondary battery of Example and Comparative Examples was performed until a battery voltage reached 3.6 V at a constant current of 1 A, followed by performing constant-voltage charge until a charging current was 0.1 A at a constant current of 3.6 A to achieve a full charge state. Following this, constant-current discharge was performed until the battery voltage reached 2.0 V at a constant current of 6 A. Such a discharge and charge cycle was repeated to measure voltage values when each current of 5, 10, 15 and 20 A was applied for 10 seconds in the state, in which the secondary battery was charged at 50%, at the 100th, 300th, and 500th cycles, and the voltage and current values were plotted to calculate an initial direct current resistance (DCR) at each cycle. Following this, in each of Example and Comparative Examples, the initial direct current resistance obtained in the above-mentioned (a) was used to measure a resistance change rate from ((direct current resistance/initial direct current resistance at each cycle)×100).

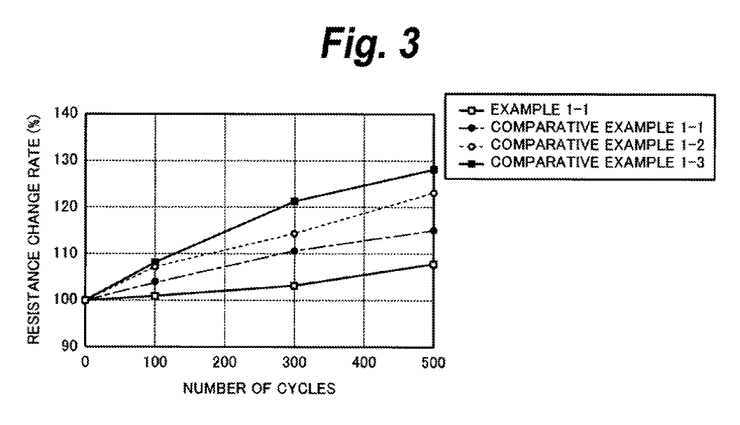

The results of the direct current resistance ratios and the resistance change rates are shown in the following Table 1. FIG. 3 is a graph showing the results of the resistance change rates.

TABLE 1

| | | | | DIRECT | | | |
|---|---|---|---|---|---|---|---|
| | FIBROUS CARBON | LOW-CRYSTALLINE CARBON | | CURRENT | RESISTANCE CHANGE RATE [%] | | |
| | CONTENT | | CONTENT | RESISTANCE | 100TH | 300TH | 500TH |
| | [PART BY MASS] | I₁₃₆₀/I₁₅₈₀ | [PART BY MASS] | RATIO [%] | CYCLE | CYCLE | CYCLE |
| EXAMPLE 1-1 | 2 | 0.3 | 2 | 93 | 101 | 103 | 108 |
| COMPARATIVE EXAMPLE 1-1 | 2 | 0.3 | 0 | 100 | 107 | 114 | 123 |
| COMPARATIVE EXAMPLE 1-2 | 4 | 0.3 | 0 | 83 | 104 | 111 | 115 |
| COMPARATIVE EXAMPLE 1-3 | 0 | 0.3 | 2 | 121 | 108 | 121 | 128 |

The results of Comparative Examples 1-1 and 1-2 exhibited that the direct current resistances were decreased with increasing the amounts of the added fibrous carbons where only the fibrous carbon was used. It was also found that the rate of increase in resistance in Comparative Example 1-2 was lower even when passing through the discharge and charge cycle.

The results of Comparative Examples 1-1 and 1-3 exhibited that, in comparison between the cases of addition of an amount of only the fibrous carbon and the equal amount of only the low-crystalline carbon, the direct current resistance in Comparative Example 1-3 using only the low-crystalline carbon was higher, and the rate of increase in resistance when passing through a discharge and charge cycle was also higher.

This is estimated to be caused by, since it is easily conceivable that there is a positive correlation between temperature in a battery and battery resistance during large-current discharge, the large amount of the film formed on the surface of the anode active material due to the decomposition of the electrolytic solution, etc., resulting in increase in battery resistance.

In contrast, it was found that, in Example 1-1 using each of the fibrous carbon and the low-crystalline carbon, the direct current resistance is high as compared to Comparative Example 1-2, in which 4 parts by mass of the fibrous carbon with high conductivity was mixed, but the direct current resistance was decreased as compared to Comparative Example 1-1, in which only the fibrous carbon was mixed, and Comparative Example 1-3, in which only the low-crystalline carbon was mixed. It was also found that, in Example 1-1, the rate of increase in resistance was low as compared to each of Comparative Example 1-1 to Comparative Example 1-3 in the respective cycle numbers, and the increase in battery resistance depending on passing through the cycle could be also suppressed as compared to Comparative Example 1-2, in which the initial direct current resistance was low.

The above results exhibited that significant suppressive effect on increase in initial direct current resistance and increase in resistance change rate depending on the number of cycles was obtained by using each of fibrous carbon and low-crystalline carbon in a cathode.

### Example 2

In the examples described below, each of carbon materials with different R-values (I₁₃₆₀/I₁₅₈₀) was used to form a cathode active material layer, and a resistance change rate at the 500th cycle was measured.

### Example 2-1

A cylindrical nonaqueous electrolyte secondary battery using a cathode containing 2 parts by mass of carbon material with an R-value (I₁₃₆₀/I₁₅₈₀) of 0.3 and 2 parts by mass of fibrous carbon was produced by the same method as in Example 1-1.

### Example 2-2

A cylindrical nonaqueous electrolyte secondary battery was produced by the same method as in Example 1-1 except that temperature of heat treatment of coal-tar pitch was varied to use a carbon material with an R-value (I₁₃₆₀/I₁₅₈₀) of 0.4.

### Example 2-3

A cylindrical nonaqueous electrolyte secondary battery was produced by the same method as in Example 1-1 except that temperature of heat treatment of coal-tar pitch was varied to use a carbon material with an R-value (I₁₃₆₀/I₁₅₈₀) of 0.8.

### Comparative Example 2-1

A cylindrical nonaqueous electrolyte secondary battery was produced by the same method as in Example 1-1 except that temperature of heat treatment of coal-tar pitch was varied to use a carbon material with an R-value (I₁₃₆₀/I₁₅₈₀) of 0.15.

### Comparative Example 2-2

A cylindrical nonaqueous electrolyte secondary battery was produced by the same method as in Example 1-1 except that temperature of heat treatment of coal-tar pitch was varied to use a carbon material with an R-value (I₁₃₆₀/I₁₅₈₀) of 1.0.

### (c) Cycle Test

Constant-current charge of each cylindrical nonaqueous electrolyte secondary battery of Example and Comparative Examples was performed until a battery voltage reached 3.6 V at a constant current of 1 A, followed by measuring a voltage value when each current of 5, 10, 15 and 20 A was applied for 10 seconds in the state in which the secondary battery was charged at 50%. Subsequently, the gradients of lines formed by plotting the measured voltage and current values were calculated as initial direct current resistances (DCR).

Following this, constant-voltage charge was performed until a charging current was 0.1 A at a constant current of 3.6 A to achieve a full charge state. Subsequently, constant-current discharge was performed until the battery voltage reached 2.0 V at a constant current of 6 A. Such a discharge and charge cycle was repeated to measure a voltage value when each current of 5, 10, 15 and 20 A was applied for 10 seconds in the state, in which the secondary battery was charged at 50%, at the 500th cycle, and the voltage and current values were plotted to calculate an initial direct current resistance (DCR) at the 500th cycle. Following this, in each of Example and Comparative Examples, a resistance change rate was measured from ((direct current resistance/initial direct current resistance at the 500th cycle)×100).

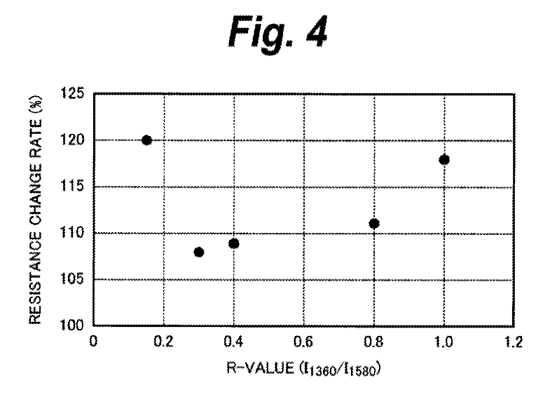

The results of the direct current resistance ratios and the resistance change rates at 500th cycle are shown in FIG. 4.

As is clear from FIG. 4, the resistance change rate at 500th cycle in accordance with Example 2-1 or 2-3 with an R-value (I₁₃₆₀/I₁₅₈₀) of 0.3 or more and 0.8 or less was extremely low as compared to Comparative Examples 2-1 and 2-2 with R-values (I₁₃₆₀/I₁₅₈₀) of 0.15 and 1.0.

It was found that, particularly, in Examples 2-1 and 2-2 with R-values (I₁₃₆₀/I₁₅₈₀) of 0.3 and 0.4, the resistance change rates were 10% or lower, which were extremely low, and an effect of suppression of increase in battery resistance could be significantly obtained even when 500 cycles of discharge and charge were carried out at a large current of 6 A.

The results described above exhibited that inclusion of: a carbon material, of which a ratio (I₁₃₆₀/I₁₅₈₀) of a peak intensity (I₁₃₆₀) at 1,360 cm⁻¹ to a peak intensity (I₁₅₈₀) at 1,580 cm⁻¹, obtained by Raman spectrum analysis through measurement using argon laser radiation at a wavelength of 514.52 nm, was 0.25 or more and 0.8 or less; and fibrous carbon, in a cathode, could result in suppression of increase in resistance change rate with passing through a discharge and charge cycle.

For example, the numerical values indicated in the above-mentioned embodiment are mere examples, and a numerical value different therefrom may be used as needed.

Further, LiFePO₄ was used as a lithium phosphate compound having an olivine structure in Examples, but the effect of the patent application is caused by combination of conductive carbons such as low-crystalline carbon and fibrous carbon and is not limited to the compositions of Examples. As the lithium phosphate compound, another cathode active material having an olivine structure represented by LiMₓPO₄ (0≦x≦1.0) may be also applied. For example, a compound with some irons replaced by other elements for structural stability, etc., represented by the following Chemical Formula II:

LiFe₁₋ₓMₓPO₄ (Chemical Formula II)

(wherein M is at least one selected from the group consisting of cobalt (Co), manganese (Mn), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W) and zirconium (Zr); and X is, e.g., 0<x<1.0, preferably 0<x≦0.8.)

A secondary battery, to which this application is applied, may be also used in not only a cylindrical battery but also various types of batteries, such as a square-shaped battery or a thin battery sheathed with, e.g., a laminated film. This application may also be applied not only to the secondary battery but also to a primary battery.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A nonaqueous electrolyte battery comprising:
a cathode having a cathode active material layer including a lithium phosphate compound having an olivine structure;
an anode having an anode active material; and
a nonaqueous electrolyte,
wherein the cathode active material layer includes:
a carbon material, of which a ratio of a peak intensity at 1,360 cm⁻¹ to a peak intensity at 1,580 cm⁻¹, obtained by Raman spectrum analysis through measurement using argon laser radiation at a wavelength of 514.52 nm, is 0.25 or more and 0.8 or less; and
fibrous carbon.

2. The nonaqueous electrolyte battery according to claim 1, wherein the lithium phosphate compound is represented by Chemical Formula I:
LiMₓPO₄
wherein M is at least one selected from the group consisting of cobalt, manganese, iron, nickel, magnesium, aluminum, boron, titanium, vanadium, niobium, copper, zinc, molybdenum, calcium, strontium, tungsten and zirconium; and X is 0≦X≦1.

3. The nonaqueous electrolyte battery according to claim 1, wherein a mean particle diameter of the lithium phosphate compound is 50 nm or larger and 500 nm or smaller.

4. A cathode comprising:
a carbon material, of which a ratio of a peak intensity at 1,360 cm⁻¹ to a peak intensity at 1,580 cm⁻¹, obtained by Raman spectrum analysis through measurement using argon laser radiation at a wavelength of 514.52 nm, is 0.25 or more and 0.8 or less; and
fibrous carbon.
